(19) United States
(12) Patent Application Publication
(10) Pub. No.: US 2017/0211708 A1
(43) Pub. Date: Jul. 27, 2017

(54) PROTECTIVE COMPOSITE SURFACES

(71) Applicant: George KIM, Canmore (CA)

(72) Inventor: George KIM, Canmore (CA)

(21) Appl. No.: 15/328,040

(22) PCT Filed: Jul. 22, 2015
(86) PCT No.: PCT/CA2015/050689

§ 371 Date: Jan. 22, 2017

Related U.S. Application Data
(60) Provisional application No. 62/028,142, filed on Jul. 23, 2014.

(51) Int. Cl. F16K 5/06; C22B 3/02; C23C 28/00; C23C 4/10

(52) U.S. Cl. CPC F16K 5/0657; C23C 4/10; C22B 3/02; C23C 28/3455; C23C 28/322

(57) ABSTRACT

A machine component at least partially covered with a protective composite surface for providing corrosion protection and wear resistance comprises: a first layer of dielectric ceramic and/or polymer material in contact with an outer surface of the machine component; and a second layer of monolithic metal, reinforced metal, or metal alloy formed over the first layer by a sheet metal forming process.

### CROSS-REFERENCE TO RELATED APPLICATIONS

The present utility application is the National Phase filing under 35 U.S.C. 371 of US Provisional application for Patent No. 62/028,142 filed 23 Jul. 2014 under 35 U.S.C. 119(e) and International Application No.: PCT/CA2015/050689, entitled “PROTECTIVE COMPOSITE SURFACES”, filed 22 Jul. 2015.

### FIELD OF THE INVENTION

The invention relates to the provision of protective layers for machine components designed for use under harsh conditions including corrosive environments as well as environments subjected to high temperatures, wear and pressures. More specifically, the invention relates to surface enhancements for such machine components to improve their lifetime and performance.

### BACKGROUND OF THE INVENTION

Machine components used in harsh corrosive environments are employed in diverse industries such as oil and gas exploration and production, chemical and petrochemical industries, as well as mining and mineral processing, among others. In many instances, the corrosion resistance of machine components may be enhanced by application of one or more barrier coatings or layers provided to exclude the corrosive environment from contact with the machine component and ensure product longevity in corrosive environments.

In one particular example of harsh environments relating to mineral processing, nickel and cobalt are extracted from lateritic ores using a process known as pressure acid leaching. This process employs autoclaves and requires the use of extremely severe processing conditions (250° C., greater than 400 kPa pressure and 90% sulfuric acid solution). In addition to the severely corrosive nature of the acid solution, up to 30% of abrasive solids are typically present in the slurry being processed.

Coated metal seated valve balls are among the machine components used in the autoclaves used to conduct the pressure acid leaching process. These valve balls must resist abrasion, erosion and corrosion at extreme temperatures and pressures. In addition, the ball material must possess sufficient strength to resist the high torque induced during actuation. Since no known single material meets all of these requirements, machine components have been modified by depositing protective outer layers in the form of spray coatings using processes such as thermal or cold spraying (including vacuum plasma spraying). A typical solution is to apply a protective two-layer coating consisting of a corrosion-resistant metallic bond coat and a wear-resistant ceramic top coat to the valve ball and seat surfaces. The role of the bond coat is to provide enhanced adhesion between the component surface and top coat and to provide a corrosion barrier.

Operating conditions similar to those of pressure acid leaching of lateritic nickel ores are employed in a typical gold leaching process, albeit at lower temperatures and pressures. The gold leaching autoclave process typically employs valve balls with a nickel-chromium bond coat and chromium oxide blend with silicon oxide and aluminum oxide as the top coat. It has been established that this combination of coatings is not optimal for pressure acid leaching of lateritic nickel ores (Kim et al., Proceedings of the First International Thermal Spray Conference, 2000, p. 1149-1153).

One past solution to this particular industrial problem was developed by the present inventor and includes the provision of a nanostructured titanium oxide ceramic coating to the valve balls and seats to enhance wear resistance. Occasionally a metal layer is deposited in order to provide better adhesion between the ceramic top coat and the metal component, as well as to act as a corrosion barrier to protect the metal component surface.

This vacuum plasma spray process yields a fairly dense coating with reduced oxides and until now has generally been considered the best method for depositing a metal bond coat layer on a machine component such as a valve ball.

Additional coatings for valve balls used in various applications have been described, for example, in European patent EP 0242927; U.S. Pat. Nos. 3,438,388, 3,450,151, 3,825,030, 4,004,776, 4,184,507, 4,928,921, 5,055,361, 5,141,018, 6,591,859, and 6,698,712; published US Patent Application Publication No. 20030111113; and International Patent Publication Nos. WO 2001033120 and WO 2013142833.

In addition, US Patent Publication No. 20130244054 to Chu et al. describes a composite material comprising a titanium alloy substrate with a metallic glass layer disposed thereon. The metallic glass layer may be Zr-based metallic glass, Mg-based metallic glass, La-based metallic glass, Pd-based metallic glass or Cu-based metallic glass. Sputtering is used as the deposition method and the metallic glass layer is 50 nm to 200 nm.

US Patent Publication No. 20130084450 to Murata et al. describes a corrosion-resistant member which includes a metal or ceramic substrate and one layer of a corrosion-resistant film that contains yttria as a main component. It is described that the film is preferably sprayed by gas plasma spraying.

US Patent Publication No. 20140004270 to Sherman et al. describes a method and apparatus for forming clad metal products such as a clad pipe or tube. The method includes the step of providing a metal substrate with a cladding composition along an interior cavity of the substrate using a heat source to initiate metallurgical bonding of the cladding material onto the substrate. The cladding composition may form a corrosion-resistant alloy, a metal, or a nanocomposite.

US Patent Publication No. 20130202476 to Hellman et al. describes a method for manufacturing a component (such as a valve, pump casing or ductwork component) with hot isostatic pressing. The method includes the steps of forming a capsule for containing metallic powder, manufacturing a core part with a center and a layer of second material forming the shape of the outer surface of the component to be manufactured, and using the core for hot isostatic pressing into the capsule containing metallic powder and a cladding material to compact the metallic powder and cladding material and form the component.

US Patent Publication No. 20130152652 to Allwood et al. describes a spin-forming process for manufacturing an article of a required shape. This process differs from conventional spin forming in replacement of a conventional mandrel with at least two supports for bearing against a surface of the workpiece, which is rotatable with respect to the two supports.

U.S. Pat. No. 8,147,980 to Bhide describes a metal matrix ceramic composite which includes a wearing portion formed by a ceramic cake impregnated by metal. The ceramic cake includes a ceramic grain comprising at least alumina and grains comprising a carbide material.

U.S. Pat. No. 5,316,863 to Johnson et al. describes a self-brazing laminated structure. In the structure, an aluminum or aluminum alloy substrate carries on one or both surfaces thereof, particles of a metal capable of forming in situ a eutectic alloy with the substrate when the sheet is heated. The eutectic-forming metal particles are typically of powder consistency and may consist of Si, Cu, Ge or Zn, but Si is preferred. The eutectic-forming metal particles and flux particles on the surface of the substrate are preferably covered by a metal foil such as aluminum which is then bonded to the substrate such that the particles are held between the outer foil and the substrate. This laminate structure has the advantage that it is self-brazing in that it is ready for brazing without any application of brazing flux.

US Patent Publication No. 20140087202 to Wang et al. describes a metal matrix ceramic composite formed by permeating at least part of a matrix metal into an array of ceramic granules by means of squeeze-casting.

U.S. Pat. No. 5,350,637 to Ketcham et al. describes microlaminated composites with laminar structures wherein ceramic foils are bonded directly to ductile, semi-brittle or brittle substrate materials which may include metals. Presintered sheets and foils are used in the fabrication of the composites. Thus sintering of the ceramic laminae precedes microlaminate fabrication, permitting full non-destructive inspection of the ceramic, metallic, or other laminae by optical, X-ray, or other methods prior to composite fabrication.

US Patent Application No. 20130078480 to Sachdev et al. describes methods for enhancing the corrosion resistance of magnesium alloy articles (exemplified by automotive parts formed by stamping sheet metal) by application of a corrosion-resistant ductile metal coating such as aluminum or zinc. Spray coating methods are described as the main method for providing the coating. Such spray coating methods may include thermal or cold spraying (including vacuum plasma spraying). In one embodiment, a consumable aluminum or aluminum alloy cylinder rotating about its cylindrical axis with its cylindrical surface in contact with the magnesium-sheared edge may be traversed around the perimeter of the sheet. By appropriately adjusting the rotational speed and the traverse rate, sufficient frictional heat may be generated to cause some of the aluminum to adhere to and be deposited on the magnesium edge.

As described hereinbelow, the present inventor has identified significant shortcomings in prior art technologies for providing protective surfaces to machine components to provide protection against harsh environments and has developed the present invention in efforts to address these shortcomings.

### SUMMARY OF THE INVENTION

In accordance with one aspect of the invention, there is provided a machine component at least partially covered with a protective composite surface for providing corrosion protection and wear resistance, the protective composite surface comprising: a first layer of dielectric ceramic and/or polymer material in contact with an outer surface of the machine component; and a second layer of corrosion-resistant monolithic metal, reinforced metal, or metal alloy formed over the first layer by a sheet metal forming process.

In accordance with another aspect of the invention, there is provided a process for manufacturing a machine component at least partially covered with a protective composite surface for providing corrosion protection and wear resistance, the process comprising: applying a first layer of dielectric ceramic and/or polymer material to an outer surface of the machine component; curing the first layer; and covering the first layer with a second layer formed of a corrosion-resistant monolithic metal, reinforced metal, or metal alloy by a sheet metal forming process.

In accordance with another aspect of the invention, there is provided a valve ball for use in an autoclave of a high pressure acid leaching process, the valve ball provided with a protective composite surface for providing corrosion protection and wear resistance, the protective composite surface comprising: a first layer of dielectric ceramic and/or polymer material in contact with an outer surface of the valve ball; and a second layer of corrosion-resistant monolithic metal, reinforced metal, or metal alloy formed over the first layer by a sheet metal forming process.

In certain embodiments, the sheet metal forming process is selected from the group consisting of sheet metal bending, sheet metal roll forming, sheet metal spinning, sheet metal deep drawing and sheet metal stretch forming.

In certain embodiments, the second layer is a monolithic metal selected from the group consisting of tantalum, titanium and molybdenum.

In certain embodiments, the second layer is monolithic tantalum having a thickness greater than about 1 mm.

In certain embodiments, the second layer is formed of reinforced metal with a ceramic reinforcement selected from the group consisting of oxides, carbides and nitrides.

In certain embodiments, the outer surface of the second layer is a nano-structured layer which is formed prior to the sheet metal forming process or formed by the sheet metal forming process.

In certain embodiments, the outer surface of the second layer is further provided with a nano-structured thermal sprayed ceramic layer.

In certain embodiments, the thermal sprayed layer is chromia, titania, zirconia, or a composite thereof.

In certain embodiments, the second layer further comprises a self-fluxing coating applied to sheet metal prior to the sheet metal forming process.

In certain embodiments, wherein the dielectric ceramic material is selected from the group consisting of aluminum oxide, zirconium oxide and chromium oxide.

In certain embodiments, the dielectric ceramic material is zirconium oxide.

In certain embodiments, the dielectric ceramic material comprises ceramic beads with an average diameter between about 50 μm to about 200 μm in an organic and/or inorganic dielectric matrix.

In certain embodiments, the machine component is a combination of a valve ball and a valve ball seat.

In certain embodiments, the substrate metal of one or more of the valve body, the ball and the seat is formed of titanium or coated with titanium.

### BRIEF DESCRIPTION OF THE DRAWINGS

Various objects, features and advantages of the invention will be apparent from the following description of particular embodiments of the invention, as illustrated in the accompanying drawings. The drawings of machine components are not necessarily to scale. Instead, emphasis is placed upon illustrating the principles of various embodiments of the invention. Similar reference numerals indicate similar features.

FIG. 1A is a scanning electron micrograph showing a top coat of monolithic tantalum applied to a valve ball according to a prior art process using vacuum plasma spray coating prior to exposure of the valve ball to high pressure acid leaching process conditions. Few surface irregularities are visible.

FIG. 1B is a scanning electron micrograph showing a top coat of monolithic tantalum applied to a valve ball according to a prior art process using vacuum plasma spray coating after exposure of the valve ball to high pressure acid leaching process conditions. Many surface irregularities are visible.

FIG. 2 is a schematic cross-sectional view of a valve 10 including a valve body 12 and a ball 14 according to one embodiment of the present invention. The sheet metal formed layer 20 and the intermediate dielectric layer 22 are visible in the magnified inset.

FIG. 3 is a layered, partially-cut away view of a section of the ball 14 showing the sheet metal formed layer 20, the intermediate dielectric layer 22 and the ball substrate surface layer 24 according to the embodiment of FIG. 2.

FIG. 4 is a shell combination view of the ball 14 of the embodiment of FIGS. 2 and 3.

FIGS. 5A, 5B and 5C are photographs of various views of a ball of a valve ball with a protective monolithic tantalum layer provided by sheet metal spinning according to one embodiment of the present invention. The photographs confirm that a smooth protective dense layer of tantalum was successfully added to the intermediate dielectric layer by sheet metal spinning, while retaining the original shape of the ball.

FIG. 6A is a cross-sectional electron micrograph (unetched) of the tantalum layer before performing the metal spinning process.

FIG. 6B is a cross-sectional electron micrograph (unetched) of the tantalum layer after performing the metal spinning process.

FIG. 7A is a cross-sectional electron micrograph (with etching) of the tantalum layer before performing the metal spinning process.

FIG. 7B is a cross-sectional electron micrograph (with etching) of the tantalum layer after performing the metal spinning process.

### DETAILED DESCRIPTION OF THE INVENTION

### Rationale

The present inventor has conducted studies of machine components subjected to single and multi-layer coatings provided by thermal or cold spraying (including vacuum plasma spraying; see for example Kim et al, Nanostructured Materials Processing, Properties, and Applications (Chapter 3), 2007, 2nd Edition, Carl C. Koch ed., William Andrew Publishing). Characterization of failed components have shown that there are flaws within applied metal bond coats that eventually lead to their degradation and result in the formation of a galvanic cell with the metal of the component surface (wherein an electrical current flows from one metal to the other metal). This galvanic cell results in the production of hydrogen in the vicinity which in turn can embrittle the bond coat and component surface. The hydrogen embrittlement leads to the formation of cracks and therefore compromises the mechanical integrity of the coating and protective surface.

There are limited technical and economical choices for application of a dense oxide-free coating on machine components, particularly those in relatively complex forms such as valve balls and seats.

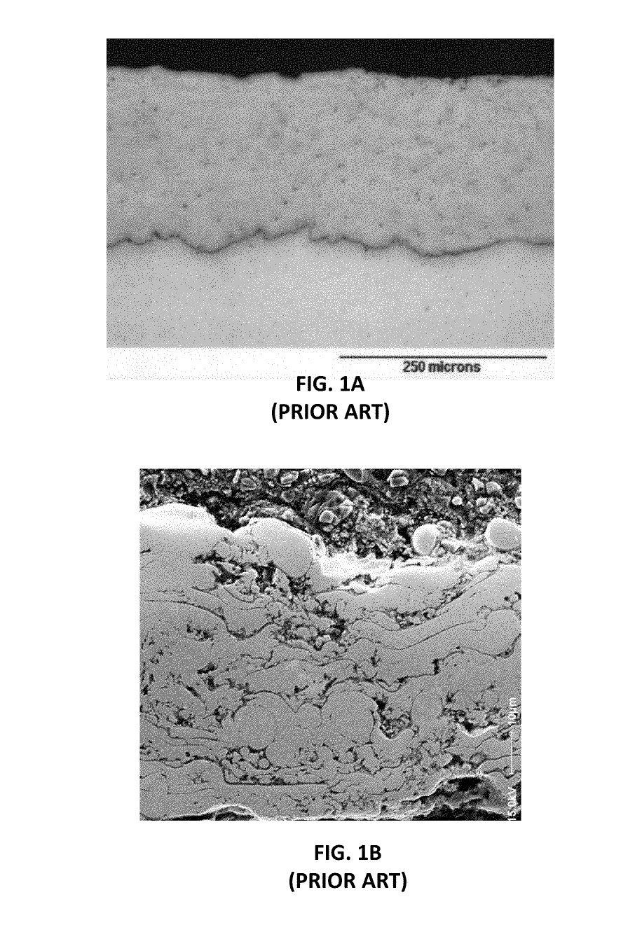

The present inventor has recently and surprisingly discovered that current methods for manufacturing dual-layer protective coatings for machine components used in nickel-cobalt high pressure acid leaching are more susceptible to corrosion damage than previously expected. Since the base material is relatively inert to the corrosive liquid, the key function of the bond coat is to enhance bond strength with the ceramic top coat. The most notable differences in quality between coatings applied via vacuum plasma spray and atmospheric pressure spray were found when spraying metals. The inert, reduced pressure ambient of the vacuum plasma spray system allows for the application of dense, oxide-free titanium and tantalum coatings. These superior features are critical for many instances where the metallic bond coat is relied upon as a corrosion barrier. In high pressure acid leaching processing environments, however, the evidence clearly shows attack of the tantalum bond coat as shown in the scanning electron microscope micrographs shown in FIG. 1A (tantalum coat prior to use in high pressure acid leaching processing environment) and FIG. 1B (tantalum coat subsequent to use in high pressure acid leaching processing environment).

The present inventor has discovered that the limitations of the deposition methods (which include imperfect (nonhomogeneous) structures, high costs, extensive processing times, and low applicable thicknesses of coatings) may be overcome by providing an outer metallic layer from a chemically inert thicker sheet metal material and has made the surprising discovery that sheet metal forming methods are suitable for this purpose. In addition, it was discovered by the present inventor that providing the protective surface as a composite which includes an intermediate dielectric layer between the component surface and the protective metal layer would serve to prevent the creation of a galvanic cell which leads to degradation of the quality of the protective surface (a phenomenon also discovered by the present inventor).

Provision of a nanostructured surface provides a protective surface with enhanced wear and corrosion resistance. In accordance with the present invention, sheet metal forming methods provide a nanostructured surface either by initiating the sheet metal forming process with a nanostructured metal sheet or by generating a nanostructured surface during the sheet metal forming process.

The present inventor has also recognized that a protective composite surface for a machine component which includes a sheet metal formed layer and an intermediate dielectric layer can be manufactured for a reduced cost relative to the protective surfaces formed using vacuum plasma spray and similar processes while providing longer lifetimes and enhanced performance.

### Sheet Metal and Sheet Metal Forming Processes

“Sheet metal” is defined herein as a metal shaped by an industrial process into a thin, flat piece. Sheet metal is a major form of metal used in various metalworking processes because it can be cut and bent very precisely into a variety of shapes. The major sheet metal forming methods compatible with the present invention are sheet bending, roll forming, spinning, deep drawing and stretch forming.

Sheet Metal Bending—

Sheet metal bending is a sheet metal forming process that produces a V-shape, U-shape, or channel shape along a straight axis in sheet metal. Commonly used equipment for metal bending includes box and pan brakes, brake presses, and other specialized machine presses. Typical products made using sheet metal bending are boxes such as electrical enclosures and rectangular ductwork. In press brake forming, a work piece is positioned over the die block and the die block presses the sheet to form a shape. Usually bending has to overcome both tensile stresses and compressive stresses. During the bending process, the residual stresses cause the material to spring back towards its original position, so the sheet must be over-bent to achieve the proper bend angle. The amount of spring back is dependent on the material, and the type of forming. When sheet metal is bent, it stretches in length. The bend deduction is the amount the sheet metal will stretch when bent as measured from the outside edges of the bend. The bend radius refers to the inside radius. The formed bend radius is dependent upon the dies used, the material properties, and the material thickness.

Roll Forming—

Roll forming is a continuous bending operation in which a long strip of sheet metal (typically coiled steel) is passed through sets of rolls mounted on consecutive stands, each set performing only an incremental part of the bend, until the desired cross-section profile is obtained. Roll forming is ideal for producing constant-profile parts with long lengths and in large quantities. Roll forming machines are available that produce shapes of different sizes and material thicknesses using the same rolls. Variations in size are achieved by making the distances between the rolls variable by manual adjustment or computerized controls, allowing for rapid changeover. These specialized mills are prevalent in the light gauge framing industry where metal studs and tracks of standardized profiles and thicknesses are used.

Metal Spinning—

Metal spinning, also known as spin forming, spinning, spun metal manufacturing or metal turning is a metalworking process by which a disc or tube of metal is rotated at high speed and formed into an axially symmetric part. Spinning can be performed by hand or by a lathe under computer numerical control (CNC). Metal spinning ranges from an artisan's specialty to the most advantageous way to form round metal parts for commercial applications. Artisans use the process to produce architectural detail, specialty lighting, decorative household goods and urns. Commercial applications include rocket nose cones, cookware, gas cylinders, brass instrument bells, and waste receptacles. Virtually any ductile metal may be formed, from aluminum or stainless steel, to high-strength, high-temperature alloys. The diameter and depth of formed parts are limited only by the size of the equipment available.

In the metal spinning process, a formed block is mounted in the drive section of a lathe. A pre-sized metal disk is then clamped against the block by a pressure pad, which is attached to the tailstock. The block and workpiece are then rotated together at high speeds. A localized force is then applied to the workpiece to cause it to flow over the block. The force is usually applied via various levered tools. Simple workpieces are just removed from the block, but more complex shapes may require a multi-piece block. Extremely complex shapes can be spun over ice forms, which then melt away after spinning. Because the final diameter of the workpiece is always less than the starting diameter the workpiece must thicken, elongate radially, or buckle circumferentially.

In a process known as “Hot Spinning,” a piece of metal on a lathe and with high heat from a torch the metal is heated. Once heated, the metal is then shaped as the tool on the lathe presses against the heated surface forcing it to distort as it spins. Parts can then be shaped or necked down to a smaller diameter with little force exerted, providing a seamless shoulder.

Deep Drawing—

Deep drawing is a sheet metal forming process in which a sheet metal blank is radially drawn into a forming die by the mechanical action of a punch. It is thus a shape transformation process with material retention. The process is considered “deep” drawing when the depth of the drawn part exceeds its diameter. This is achieved by redrawing the part through a series of dies. The flange region (sheet metal in the die shoulder area) experiences a radial drawing stress and a tangential compressive stress due to the material retention property. These compressive stresses (hoop stresses) result in flange wrinkles (wrinkles of the first order). Wrinkles can be prevented by using a blank holder, the function of which is to facilitate controlled material flow into the die radius.

The total drawing load consists of the ideal forming load and an additional component to compensate for friction in the contacting areas of the flange region and bending forces as well as unbending forces at the die radius. The forming load is transferred from the punch radius through the drawn part wall into the deformation region (sheet metal flange). In the drawn part wall, which is in contact with the punch, the hoop strain is zero whereby the plane strain condition is reached. Typically, the strain condition is only approximately planar. Due to tensile forces acting in the part wall, wall thinning is prominent and results in an uneven part wall thickness. It can be observed that the part of the wall where its thickness is lowest is the point where the part wall loses contact with the punch, i.e., at the punch radius. The thickness of the thinnest part determines the maximum stress that can be transferred to the deformation zone. Due to material volume constancy, the flange thickens and results in blank holder contact at the outer boundary rather than on the entire surface. The maximum stress that can be safely transferred from the punch to the blank sets a limit on the maximum blank size (initial blank diameter in the case of rotationally symmetrical blanks). An indicator of material formability is the limiting drawing ratio (LDR), defined as the ratio of the maximum blank diameter that can be safely drawn into a cup without flange to the punch diameter. Determination of the LDR for complex components is difficult and hence the part is inspected for critical areas for which an approximation is possible. During severe deep drawing the material work hardens and it may be necessary to anneal the parts in controlled atmosphere ovens to restore the original elasticity of the material. Commercial applications of this metal shaping process often involve complex geometries with straight sides and radii. In such a case, the term “stamping” is used in order to distinguish between deep drawing (radial tension-tangential compression) and stretch-and-bend (along the straight sides).

Stretch Forming—

Stretch forming is a metal forming process in which a piece of sheet metal is stretched and bent simultaneously over a die in order to form large contoured parts. Stretch forming is performed on a stretch press, in which a piece of sheet metal is securely gripped along its edges by gripping jaws. The gripping jaws are each attached to a carriage that is pulled by pneumatic or hydraulic force to stretch the sheet. The tooling used in this process is a stretch form block, called a form die, which is a solid contoured piece against which the sheet metal will be pressed. The most common stretch presses are oriented vertically, in which the form die rests on a press table that can be raised into the sheet by a hydraulic ram. As the form die is driven into the sheet, which is gripped tightly at its edges, the tensile forces increase and the sheet plastically deforms into a new shape. Horizontal stretch presses mount the form die sideways on a stationary press table, while the gripping jaws pull the sheet horizontally around the form die.

### Outer Protective Metal Layer

Depending on the sheet metal forming method used to apply the outer layer, surface grain structure refinement (i.e., nanostructure form) can be attained through plastic deformation, thereby possibly providing superior resistance to localized corrosion and to wear. The same method may be used to rebuild worn or damaged (after uniformly undercutting past the damaged depth) components. A nanostructured sheet material may also be used to form a nanostructured surface. This technology is conducive to additional surface engineering onto its resulting composite surface section.

In some embodiments, additional surface engineering is provided by thermal spraying of an additional ceramic layer. The ceramic may be chromia, titania, zirconia, or a composite thereof.

The skilled person will recognize that, depending upon the characteristics of individual machine components for which protective composite surfaces are required, more than one sheet metal forming process may be employed in manufacture of the protective composite surfaces. For example, the sheet-metal formed layer of an axially symmetric component such as the ball of a valve ball may be produced by a sheet metal forming process that is relatively easy to adapt to axially symmetric components, such as sheet metal spinning. The skilled person can, without undue experimentation, select and/or modify known sheet metal forming processes in order to generate an outer protective layer of the protective composite surface of the invention for various machine components.

In certain embodiments, the sheet-metal formed layer is coated with a self-fluxing surface layer prior to initiating the sheet metal forming process. A self-fluxing alloy is any used in thermal or cold spraying (including vacuum plasma spraying) which does not require the addition of a flux in order to wet the substrate and coalesce when heated. The provision of a self-fluxing layer on the coating is another way to provide a well-defined surface microstructure or nanostructure which will have enhanced resistance to wear and corrosion. Self-fluxing alloys are well known to the skilled person and can be provided on sheet metal surfaces according to known methods without undue experimentation.

If the outer metal protective layer is formed in more than a single step to cover the machine component (for example, the component is covered in the protective outer layer by two separate metal spinning procedures), at least one interface will exist between the two formed layers. In such cases, the interface is fused to create a hermetic seam in the outer protective layer. Such fusing can be accomplished by suitable welding methods known to those skilled in the art, such as underwater resistance welding, electron beam welding in vacuum, and gas tungsten-arc welding in vacuum or shrouded inert atmosphere. Such welding methods have been proven to be effective in sealing interfaces of tantalum and titanium. Other welding methods known to the skilled person may be equally effective.

### Intermediate Dielectric Layer

As noted above, the intermediate dielectric layer is provided as part of the protective composite in order to prevent generation of a galvanic cell between the protective sheet metal formed layer and the substrate of the machine component. The intermediate dielectric layer may also prevent corrosion of the surface of the machine component if the sheet-metal formed layer is breached. In certain embodiments, the dielectric layer is a ceramic applied in a slurry form and cured to a solid form. The dielectric layer may be provided as an oxide derivative of aluminum, zirconium or chromium, for example.

In other embodiments, the intermediate dielectric layer is provided by a dielectric polymer or by a combination of a dielectric metal oxide and a dielectric polymer. Examples of appropriate dielectric polymers may include epoxies, unsaturated polyesters, silicone and contact cement, among others.

In other embodiments, the dielectric layer includes ceramic beads having a diameter of about 50 to about 200 μm, in an organic and/or inorganic dielectric matrix. The ceramic beads may be formed of chromia, titania, zirconia, or a composite thereof. In one particular embodiment, the dielectric layer is a 50:50 volume mixture of 150 μm zirconia beads and a high-temperature anaerobic adhesive.

### Description of an Example Embodiment

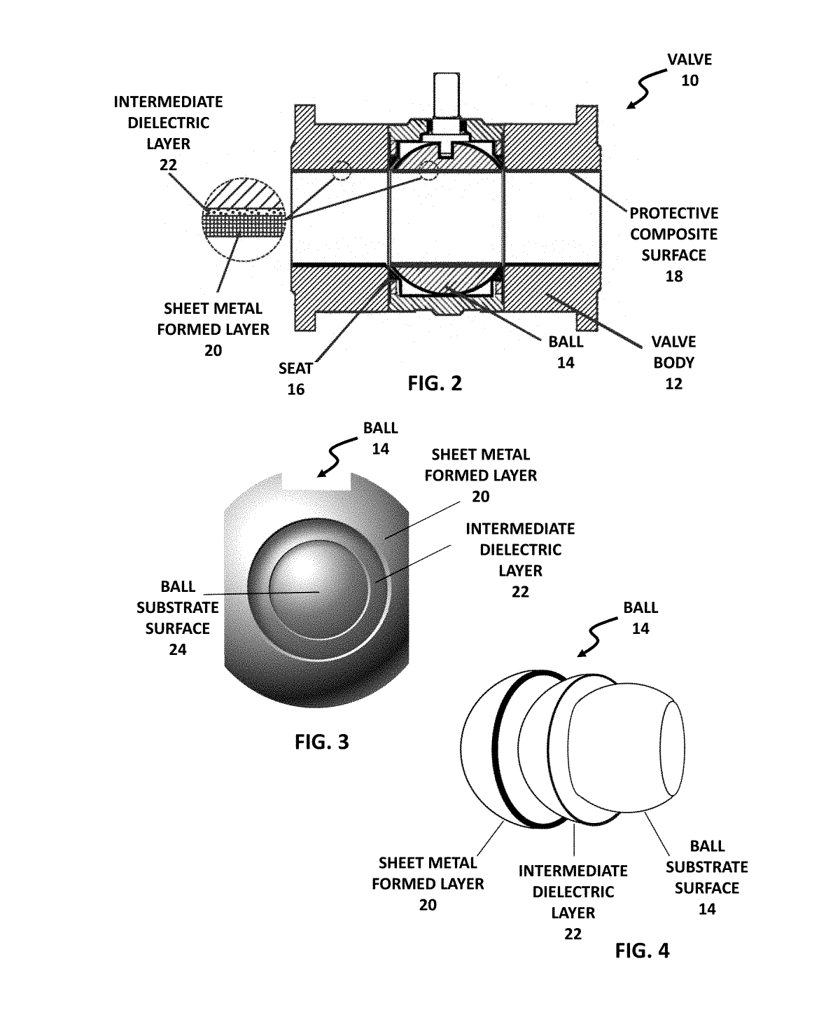

One example embodiment will now be described with reference to FIGS. 2-5. For the purposes of illustration, components depicted in the figures are not necessarily drawn to scale. Instead, emphasis is placed on highlighting the various contributions of the components to the functionality of various aspects of the invention. A number of possible alternative features are introduced during the course of the description of this example embodiment. It is to be understood that, according to the knowledge and judgment of persons skilled in the art, such alternative features may be substituted in various combinations to arrive at different embodiments of the present invention.

In this embodiment, a fully dense tantalum layer about 1 mm thick derived from metal spinning a sheet of tantalum provides an impermeable corrosion barrier far superior to the current state-of-the-art approach of providing a thinner tantalum coating having a thickness of approximately 250 μm by thermal or cold spraying (including vacuum plasma spraying). Such tantalum coatings produced using existing methods are nonhomogeneous-structured with splat boundaries, porosity, oxidation, unmelts, and other imperfections which may be attacked by acids (as shown for example, in FIG. 1B). The technology of the present invention permits the use of lower cost component materials without compromising performance of the machine component. It is expected that the protective composite surfaces of the present invention will likely result in prolonged life of the components beyond the lifetime of components provided by the current state-of-the-art coatings.

In this particular example, described with reference to FIGS. 2-5, an embodiment of the protective composite surface of the present invention was provided to protect a titanium substrate valve ball intended for use in the autoclave of a pressure acid leaching process for extraction of nickel and cobalt from laterite ores. FIG. 2 shows a schematic cross-section of a valve 10 which includes a valve body 12 and a ball 14 which makes contact with a valve ball seat 16. In this embodiment, both the ball 14 and the seat 16 are provided with the protective composite surface 18 which is shown in more detail in the inset where it can be seen that in both the valve body 12 and the ball 14, the protective composite surface 18 includes an outer sheet metal formed layer of tantalum 20 and an intermediate zirconium oxide dielectric layer 22. The layers are also shown in FIGS. 3 and 4 where it can be seen that the ball substrate surface 24 was first provided with an intermediate dielectric zirconium oxide layer 22 in a slurry form and cured to a solid form, according to known methods. Other methods of applying the intermediate dielectric layer are known to the skilled person and can be adapted for application to valve balls in alternative embodiments. In certain alternative embodiments, after manual coverage of the ball substrate surface 24 with the intermediate dielectric layer, this layer is made uniform by spinning the valve ball according to known methods.

In the next step, the ball with the cured intermediate zirconium oxide layer 22 was covered with a layer of monolithic tantalum 20 by mounting the ball on a lathe and spinning a sheet metal layer of tantalum over the intermediate zirconium oxide layer, according to known sheet metal spinning methods. In this particular embodiment, the layer of monolithic tantalum provided to the ball of the valve ball was about 1 mm thick. Alternative embodiments produced may generate layers which are thicker or thinner, but advantageously not thinner than about 250 μm.

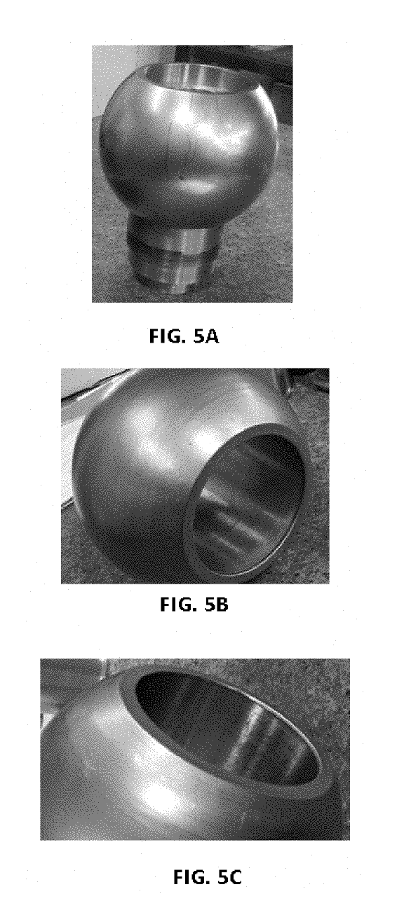

Photographs of the valve ball with the protective composite surface of this embodiment are shown in FIGS. 5A-5C and provide visual confirmation that sheet metal spinning is a useful process for providing a uniform layer of monolithic tantalum over the ball of a valve ball. Efforts are underway to characterize the tantalum sheet metal-formed layer. It is expected that micrographs obtained by electron microscopy and/or other methods, will reveal that the outer layer of the protective composite surface of this embodiment has much more regular structure and absence of irregularities such as splat boundaries, porosity, oxidation, unmelts, and other imperfections and therefore, it will be confirmed that this protective composite surface represents a significant advance over prior art coatings for protection of machine components designed for use in environments which include high temperatures and pressures as well as highly acidic and corrosive conditions.

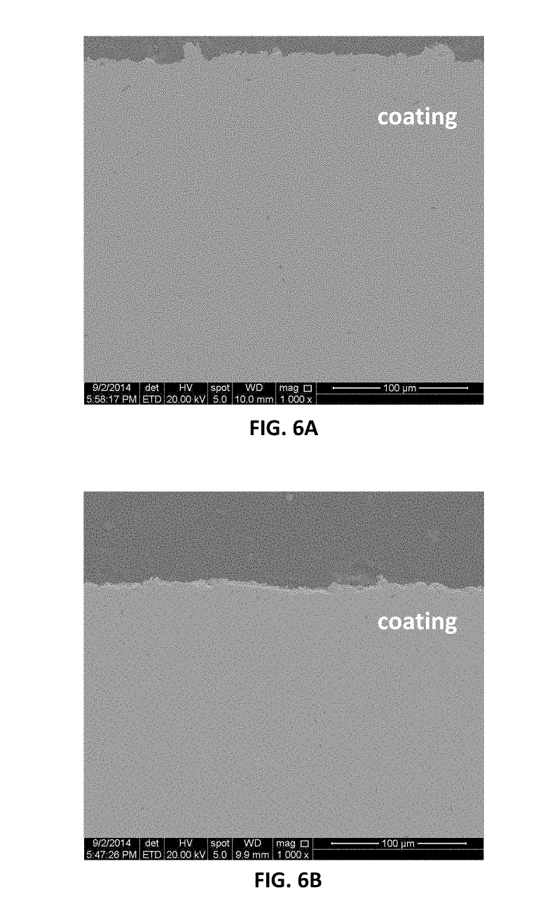

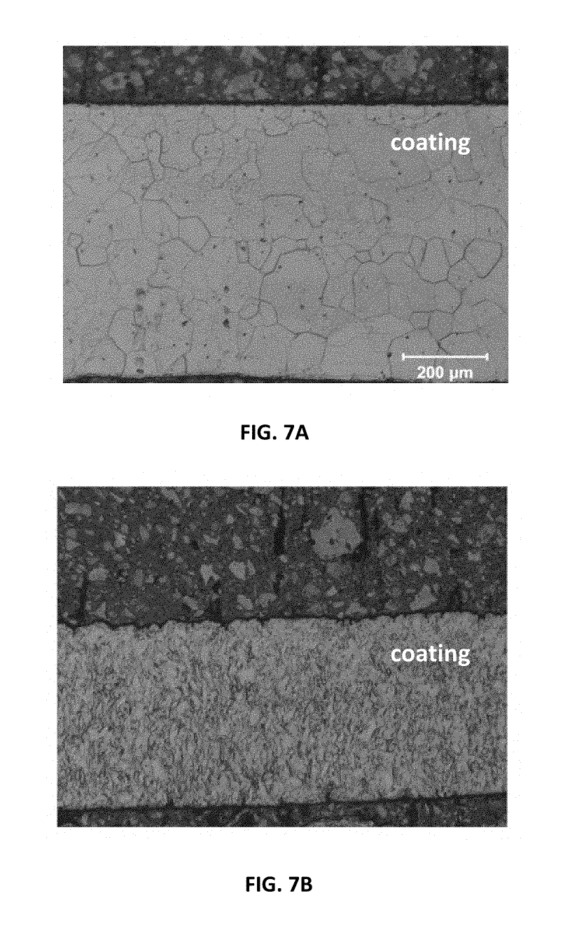

A subsequent electron microscopy analysis of a tantalum sheet before and after metal spinning on a valve ball was performed to assess the effect of metal spinning on the microstructure of the metal. Cross-sectional electron micrographs are shown in FIGS. 6 and 7. FIGS. 6A and 6B are cross-sectional electron micrographs of the tantalum layer before and after performing the metal spinning process. FIG. 6A shows the tantalum layer before metal spinning and FIG. 6B shows the tantalum layer after metal spinning. There are no signs of flaws or anomalies in the tantalum layer caused by metal spinning. FIGS. 7A and 7B are cross-sectional electron micrographs obtained using etched samples. FIG. 7A shows the tantalum layer before metal spinning and FIG. 7B shows the tantalum layer after metal spinning. It is clearly seen that metal spinning leads to grain refinement. It is expected that spinning for a longer period will produce additional grain refinement. The average hardness of the tantalum before spinning was 96 HV0.3 and after spinning the average hardness is 140 HV0.3, as determined by the Vickers hardness test. This experiment indicates that metal spinning does not produce adverse effects on the protective outer layer and in fact produces the desirable results of enhancing grain structure and hardness.

On the basis of the present evidence obtained for the example embodiment and knowledge of the current state of the art, it is reasonably and soundly predicted that machine components provided with the protective composite surfaces of various embodiments of the present invention will protect the machine components in harsh corrosive environments and will represent a significant advance in the art.

### CONCLUDING REMARKS

Although the present invention has been described and illustrated with respect to example embodiments and preferred uses thereof, the skilled person will recognize that the invention should not be limited to these example embodiments since modifications and changes can be made therein which are within the full, intended scope of the invention as understood by those skilled in the art. Each of the articles and patent documents referenced herein is incorporated herein by reference in entirety.

1. A machine component at least partially covered with a protective composite surface for providing corrosion protection and wear resistance, the protective composite surface comprising:
a) a first layer of dielectric ceramic and/or polymer material in contact with an outer surface of the machine component; and
b) a second layer of corrosion-resistant monolithic metal, reinforced metal, or metal alloy formed over the first layer by a sheet metal forming process.

2. The machine component of claim 1, wherein the sheet metal forming process is selected from the group consisting of sheet metal bending, sheet metal roll forming, sheet metal spinning, sheet metal deep drawing and sheet metal stretch forming.

3. The machine component of claim 1, wherein the second layer is a monolithic metal selected from the group consisting of tantalum, titanium and molybdenum.

4. The machine component of claim 1, wherein the second layer is monolithic tantalum having a thickness greater than about 1 mm.

5. The machine component of claim 1, wherein the second layer is formed of reinforced metal with a ceramic reinforcement selected from the group consisting of oxides, carbides and nitrides.

6. The machine component of claim 1, wherein the outer surface of the second layer is a nano-structured layer which is formed prior to the sheet metal forming process or formed by the sheet metal forming process.

7. The machine component of claim 1, wherein the outer surface of the second layer is further provided with a nano-structured thermal sprayed ceramic layer.

8. The machine component of claim 7, wherein the thermal sprayed ceramic layer is chromia, titania, zirconia, or a composite thereof.

9. The machine component of claim 1, wherein the second layer further comprises a self-fluxing coating applied to sheet metal prior to the sheet metal forming process.

10. The machine component of claim 1, wherein the dielectric ceramic material is selected from the group consisting of aluminum oxide, zirconium oxide and chromium oxide.

11. The machine component of claim 1, wherein the dielectric ceramic material is zirconium oxide.

12. The machine component of claim 1, wherein the dielectric ceramic material comprises ceramic beads with an average diameter between about 50 μm to about 200 μm in an organic and/or inorganic dielectric matrix.

13. The machine component of claim 1, which is a combination of a valve ball body, a valve ball and a valve ball seat.

14. A process for manufacturing a machine component at least partially covered with a protective composite surface for providing corrosion protection and wear resistance, the process comprising:
a) applying a first layer of dielectric ceramic and/or polymer material to an outer surface of the machine component;
b) curing the first layer; and
c) covering the first layer with a second layer formed of a corrosion-resistant monolithic metal, reinforced metal, or metal alloy by a sheet metal forming process.

15. The process of claim 14 wherein the sheet metal forming process is selected from the group consisting of sheet metal bending, sheet metal roll forming, sheet metal spinning, sheet metal deep drawing and sheet metal stretch forming.

16. The process of claim 14 wherein the second layer is a monolithic metal selected from the group consisting of tantalum, titanium and molybdenum.

17. The process of claim 14 wherein the second layer is monolithic tantalum having a thickness greater than about 1 mm.

18. The process of claim 14 wherein the second layer is formed of reinforced metal with a ceramic reinforcement selected from the group consisting of oxides, carbides and nitrides.

19. The process of claim 14 wherein the outer surface of the second layer is a nano-structured layer which is formed prior to the sheet metal forming process or formed by the sheet metal forming process.

20. The process of claim 14, wherein the outer surface of the second layer is further provided with a nano-structured thermally-sprayed ceramic layer.

21. The process of claim 20, wherein the thermally-sprayed layer is chromia, titania, or zirconia.

22. The process of claim 14 wherein the second layer further comprises a self-fluxing coating applied to sheet metal prior to the sheet metal forming process.

23. The process of claim 14 wherein the dielectric ceramic material is selected from the group consisting of aluminum oxide, zirconium oxide and chromium oxide.

24. The process of claim 14 wherein the dielectric ceramic material is zirconium oxide.

25. The process of claim 14, wherein the dielectric ceramic material comprises ceramic beads with an average diameter between about 50 μm to about 200 μm in an organic and/or inorganic dielectric matrix.

26. The process of claim 14, wherein the machine component is a combination of a valve ball body, a valve ball and a valve ball seat.

27. A valve ball for use in an autoclave of a high pressure acid leaching process, the valve ball provided with a protective composite surface for providing corrosion protection and wear resistance, the protective composite surface comprising:
a) a first layer of dielectric ceramic and/or polymer material in contact with an outer surface of the valve ball; and
b) a second layer of corrosion-resistant monolithic metal, reinforced metal, or metal alloy formed over the first layer by a sheet metal forming process.

28. The valve ball of claim 27 wherein the sheet metal forming process is selected from the group consisting of sheet metal bending, sheet metal roll forming, sheet metal spinning, sheet metal deep drawing and sheet metal stretch forming.

29. The valve ball of claim 27 wherein the second layer is a monolithic metal selected from the group consisting of tantalum, titanium and molybdenum.

30. The valve ball of claim 27 wherein the second layer is monolithic tantalum having a thickness greater than about 1 mm.

31. The valve ball of claim 27 wherein the second layer is formed of reinforced metal with a ceramic reinforcement selected from the group consisting of oxides, carbides and nitrides.

32. The valve ball of claim 27 wherein the outer surface of the second layer is a nano-structured layer which is formed prior to the sheet metal forming process or formed by the sheet metal forming process.

33. The valve ball of claim 27, wherein the outer surface of the second layer is further provided with a nano-structured thermal sprayed ceramic layer.

34. The valve ball of claim 33, wherein the thermal sprayed layer is chromia, titania, zirconia, or a composite thereof.

35. The valve ball of claim 27 wherein the second layer further comprises a self-fluxing coating applied to sheet metal prior to the sheet metal forming process.

36. The valve ball of claim 27 wherein the dielectric ceramic material is selected from the group consisting of aluminum oxide, zirconium oxide and chromium oxide.

37. The valve ball of claim 27 wherein the dielectric ceramic material is zirconium oxide.

38. The valve ball of claim 27, wherein the dielectric ceramic material comprises ceramic beads with an average diameter between about 50 μm to about 200 μm in an organic and/or inorganic dielectric matrix.

39. The valve ball of claim 27 wherein the substrate metal of one or more of the valve body, the ball and the seat is formed of titanium or coated with titanium.
